(19) United States
(12) Patent Application Publication
(10) Pub. No.: US 2014/0177898 A1
(43) Pub. Date: Jun. 26, 2014

(54) EARPUFF

(71) Applicants: Randy Granovetter, La Jolla, CA (US); Robert Dean Kutnick, Deerfield Beach, FL (US)

(72) Inventors: Randy Granovetter, La Jolla, CA (US); Robert Dean Kutnick, Deerfield Beach, FL (US)

(73) Assignee: TAIDA COMPANY, LLC, La Jolla, CA (US)

(21) Appl. No.: 14/003,268

(22) PCT Filed: Mar. 9, 2012
(86) PCT No.: PCT/US12/28463

§ 371 Date: Feb. 17, 2014

Related U.S. Application Data
(60) Provisional application No. 61/451,895, filed on Mar. 11, 2011.

(51) Int. Cl. H04R 1/10

(52) U.S. Cl. CPC H04R 1/1091
USPC 381/380

(57) ABSTRACT

An earpuff is provided. The earpuff is a one-piece structure having a first end, a second end and an inner passage therebetween. The inner passage has a first segment and a second segment. The first segment has a plurality of interior contours. The interior contours are configured to align with exterior contours of a speaker component. The second segment of the inner passage includes a bell pipe portion and a bell portion.

### RELATED APPLICATIONS

This application claims the benefit of U.S. Provisional Application No. 61/451,895, filed Mar. 11, 2011, the disclosure of which is incorporated herein by reference in its entirety.

### BACKGROUND

Wireless and mobile electronic devices are increasingly popular. Non-limiting examples of wireless and mobile electronic devices include MP3-style players, cellular phones, laptop and tablet-style computers, game controls, personal digital assistants, embedded connected devices in an automobile, embedded connected devices in a home or office, embedded connected devices in a commercial building such as a hotel or factory, embedded connected devices in a transportation facility such as an airport or train station, digital cameras, DVD players and internet protocol television (IPTV).

These wireless and mobile electronic devices often include interactive display screens, controls and sound capabilities. In some instances, the sound generated by the wireless and mobile electronic devices is transmitted through wires to one or more speakers that are positioned adjacent to, or in the ears of the user. In other instances, the generated sound can be transmitted to speakers via wireless transmission devices. A non-limiting example of a speaker system positioned adjacent to the ears of the user is headphones. Non-limiting examples of a speaker system positioned within the ears of the user are earbuds and earphones.

Earbuds and earphones refer to very small headphones that are fitted directly in the outer ear and face the ear canal without being inserted in the ear canal. In some instances earbuds and earphones can be uncomfortable and prone to falling out of the ear. It would be advantageous earbuds and earphones could be improved.

### SUMMARY OF THE INVENTION

The above objects as well as other objects not specifically enumerated are achieved by an earpuff comprising a one-piece structure having a first end, a second end and an inner passage therebetween. The inner passage has a first segment and a second segment. The first segment has a plurality of interior contours. The interior contours are configured to align with exterior contours of a speaker component. The second segment of the inner passage includes a bell pipe portion and a bell portion.

According to this invention there is also provided a method of using a speaker of an electronic device. The method includes the steps of inserting a first portion of the speaker into a first segment of an earpuff, the first portion of the speaker having a plurality of exterior contours and the first segment of the earpuff having a plurality of interior contours, the combination of the speaker and the earpuff forming an earpuff assembly, inserting the earpuff assembly into an ear of a user such that portions of the earpuff extend into portions of an ear canal and portions of the earpuff seat against portions of an outer ear and allowing the earpuff to expand against portions of the ear canal and portions of the outer ear, thereby creating a personal fit.

Various objects and advantages of the earpuff will become apparent to those skilled in the art from the following detailed description of the preferred embodiment, when read in light of the accompanying drawings.

### BRIEF DESCRIPTION OF THE DRAWINGS

FIG. 1 is a schematic view of a first embodiment of an earpuff used with a mobile electronic device.

FIG. 2 is an exploded side view, in elevation, of the earpuff of FIG. 1 and an earbud.

FIG. 3 is a perspective view of the earpuff of FIG. 1.

FIG. 4 is a side view, in elevation, of the earpuff of FIG. 1.

FIG. 5 is a perspective view of the earpuff of FIG. 1 shown with a second embodiment of a mobile electronic device.

FIG. 6 is a chart illustrating the hysteresis of the foam material of the earpuff of FIG. 1.

### DETAILED DESCRIPTION OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

The description and figures disclose an earpuff for use with an earbud or earphone. Generally, the earpuff is configured to encapsulate portions of an earbud and form a temporary earmold that allows a user to comfortably wear the earbud for extended periods of time. The term “earbud”, as used herein, is defined to mean any very small headphone that is fitted directly in portions of an outer ear or in portions of an ear canal. Non-limiting examples of earbuds include “Jbuds” marketed by JLab Audio, “Xtreme Xplosives in Ear” marketed by JVC, “Skullcandy INK'd Earbuds” marketed by Skullcandy, “Image S4” marketed by Klipsch, “MDR-EX57LP” marketed by Sony, “AH-C360” marketed by Denon and the “CX 300 II” marketed by Sennheiser.

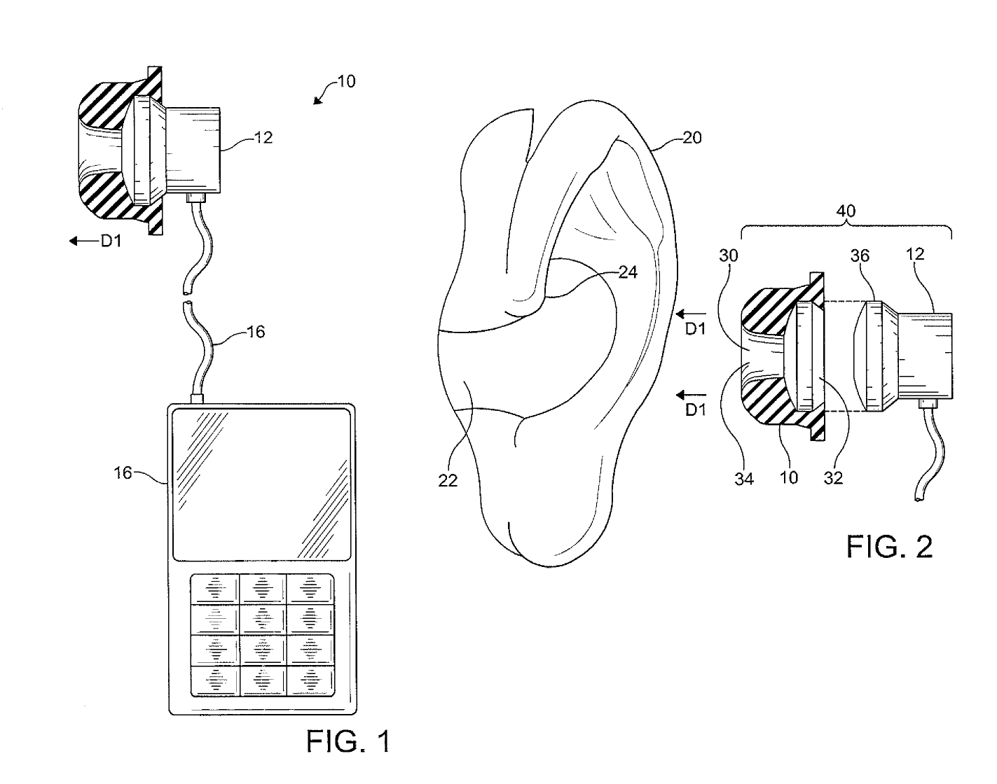

Referring now to FIG. 1, one example of an earpuff is shown generally at 10. The earpuff 10 is configured to encapsulate portions of an earbud 12 and form a temporary earmold that allows a user to comfortably wear the earbud 12 for extended periods of time. The earpuff 10 and the encapsulated earbud 12 are inserted in the direction DI into portions of an ear (not shown) of a user.

The earbud 12 includes a speaker (not shown). The speaker includes an electroacoustic transducer (not shown) that produces sound in response to an electrical audio signal input. The sound is then directed into the ear canal (not shown) of the user. The earbud 12 is connected to a mobile electronic device 14 via wires 16. In the embodiment illustrated in FIG. 1, the mobile electronic device 14 is a cell phone or a smart phone, such as the non-limiting examples of an “iphone” marketed by Apple, Inc., an “Android” marketed by AT&T or a “Blackberry” marketed by Research In Motion. However, in other embodiments, the mobile electronic device 14 can be other devices, such as the non-limiting examples of MP3-style players, laptop and tablet-style computers, game controls, personal digital assistants, embedded connected devices in an automobile, embedded connected devices in a home or office, embedded connected devices in a commercial building such as a hotel or factory, embedded connected devices in a transportation facility such as an airport or train station, digital cameras, DVD players and internet protocol television PTV).

Referring again to FIG. 1, the wires 16 are configured as a conduit for conveying the electrical audio signal generated by the mobile electronic device 14 to the earbud 12. While the embodiment illustrated in FIG. 1 shows the wires 16 connecting the mobile electronic device 14 to the earbud 12, it is within the contemplation of this invention that the electrical audio signal can be transmitted to the earbud 12 by wireless methods.

The earbud 12 illustrated in FIG. 1 is a passive device. The term “passive device”, as used herein, is defined to mean a device that relies on other electronic devices to provide electrical audio signals. While the earbud 12 illustrated in FIG. 1 is a passive device, it should be appreciated that in other embodiments, the earbud 12 can be a part of an active electronic device. The term “active electronic device”, as used herein, is defined to mean the device includes sufficient electronic components and circuitry to internally generate electrical audio signals. Active electronic devices will be discussed in more detail below.

Referring now to FIG. 2, the earpuff 10, removed from an ear 20, is illustrated apart from the earbud 12. The ear 20 includes an ear canal 22 extending in an inward direction from an outer ear 24 to the inner ear (not shown). As will be explained in more detail below, in an installed position, portions of the earpuff 10 extend into portions of the ear canal 22 and portions of the earpuff 10 seat against portions of the outer ear 24.

Referring again to FIG. 2, the earpuff 10 includes an inner passage 30. The inner passage 30 has a first segment 32 and a second segment 34. The first segment 32 of the inner passage 30 is configured to receive a first portion 36 of the earbud 12. When the earbud 12 is used without the earpuff 10, the first portion 36 of the earbud 12 is typically inserted into the ear canal 22 of the user. As will be explained in more detail below, the first segment 32 of the earpuff 10 includes interior contours that closely approximate the exterior contours of the first portion 36 of the earbud 12, such that when the first portion 36 of the earbud 12 is inserted into the first segment 32 of the earpuff 10, the interior contours of the first segment 32 and the exterior contours of the first portion 36 align, thereby securely retaining the earbud 12 within the earpuff 10.

Referring again to FIG. 2, the earpuff 10 is formed as an integral one-piece structure. The term “integral”, as used herein, is defined to mean the earpuff is formed as a single, homogenous body. While the embodiment illustrated in FIG. 2 shows the earpuff 10 as being formed as an integral one-piece structure, it is within the contemplation of this invention that the earpuff 10 can be formed from separate and distinct segments that are joined together.

In the illustrated embodiment, the earpuff 10 is formed from a biodegradable, visco-elastic, low resilience, polymeric-based open-cell foam material (hereafter “foam material”). The term “biodegradable”, as used herein, is defined to mean that the earpuff 10 is capable of being broken down into innocuous products by living things, such as for example microorganisms. The biodegradable aspect of the earpuff 10 stems from the replacement of petroleum-based ingredients forming the foam material to the use of reactive materials made from sustainable, renewable resources, such as the non-limiting example of soy. The use of the sustainable, renewable resources is accomplished while providing cushioning that is comparable, if not better, in terms of quality and performance to conventional petroleum-based foam formulas.

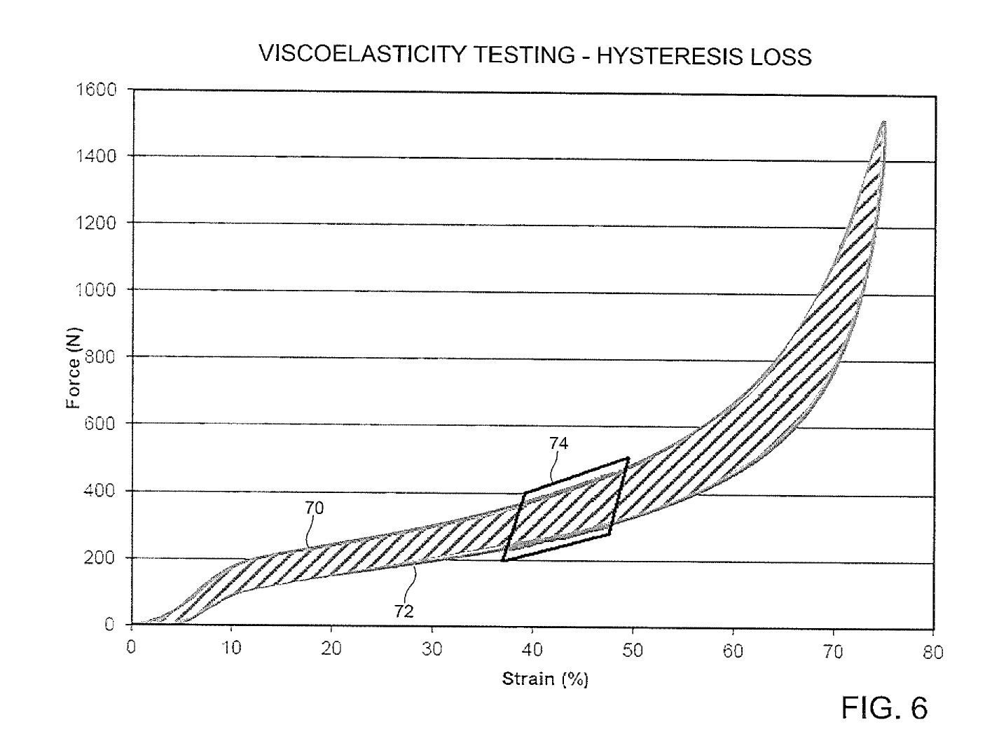

As described above, the open cell foam material forming the earpuff is a low resilience foam. The term “resilience”, as used herein, is defined to mean the surface elasticity or “springiness of the foam material. The use of the unique low resilience open cell foam material allows the earpuff to compress upon placement within and adjacent portions of an ear, and subsequent expansion against portions of the ear to create an individual personal fit. The use of the low resilience open cell foam provides superior compression and expansion as compared to traditional high resiliency foams. Referring now to FIG. 6, a graph depicting a statistical sampling of the hysteresis loss of the low resilience foam material is illustrated. The term “hysteresis loss”, as used herein, is defined to mean the energy lost during compression (loading energy) and recovery (unloading energy) of a foam. Hysteresis can be measured by testing standards such as ASTM D3574, which correlates the durability of the foam with the comfort of the foam. In a typical test conducted under ASTM D3574 standards, a foam material sample is indented by 75%±5.0% of its original thickness after one or more pre-compressions. A graph of the force and the resulting strain can be developed. The energy is defined as the area under the curve. Referring specifically to FIG. 6, the graph includes an upper curve (shown as “70”) and a lower curve (shown as “72”). The graph of FIG. 6 has a vertical axis of Force, measured in Newtons, and a horizontal axis of Strain, measured in %. As shown in FIG. 6, the desired hysteresis loss of the foam material is defined by the parallelogram 74. The parallelogram 74 has an upper boundary of approximately 50% strain at 500 Newtons and a lower boundary of approximately 37% strain at 200 Newtons. A foam material within this range provides a superior blend of resilience, comfort and durability.

The term “visco-elastic”, as used herein, is defined to mean a material that returns to an original shape upon removal of deforming forces. While the earpuff 10 has been described above as being formed from biodegradable, visco-elastic, low resiliency, polymeric-based open-cell foam material , it should be appreciated that in other embodiments the earpuff 10 can be formed from other polymeric materials, such as for example, an oil-based polymer foam having less than 50% of an oil based content. As will be explained in more detail below, the foam material is configured for several functions.

Referring again to FIG. 2, in operation the earpuff 10 and the earbud 12 are used in the following manner. First, any existing foam materials or other soft materials (not shown) covering the first portion 36 of the earbud 12 are removed. Next, the first portion 36 of the earbud 12 is inserted into the first segment 32 of the earpuff 10 such that the exterior contours of the first portion 36 of the earbud 12 align with the interior contours of the first segment 32 of the earpuff 10 as shown in FIG. 1. In this position, the first portion 36 of the earbud 12 is securely retained within the first segment 32 of the earpuff 10. The assembly of the earbud 12 into the earpuff 10 forms an earpuff assembly 40. The earpuff assembly 40 is inserted into portions of the ear canal 22 of the user such that the foam material of the earpuff 10 compresses and subsequently expands to the approximate shape and dimensions of the portions of the user's ear canal 22 and outer ear 24 in contact with the earpuff 10. In this manner, the foam material of the earpuff 10 is self-adjusting and form fitting, thereby creating an original personal fit to the exact shape of the user's ear.

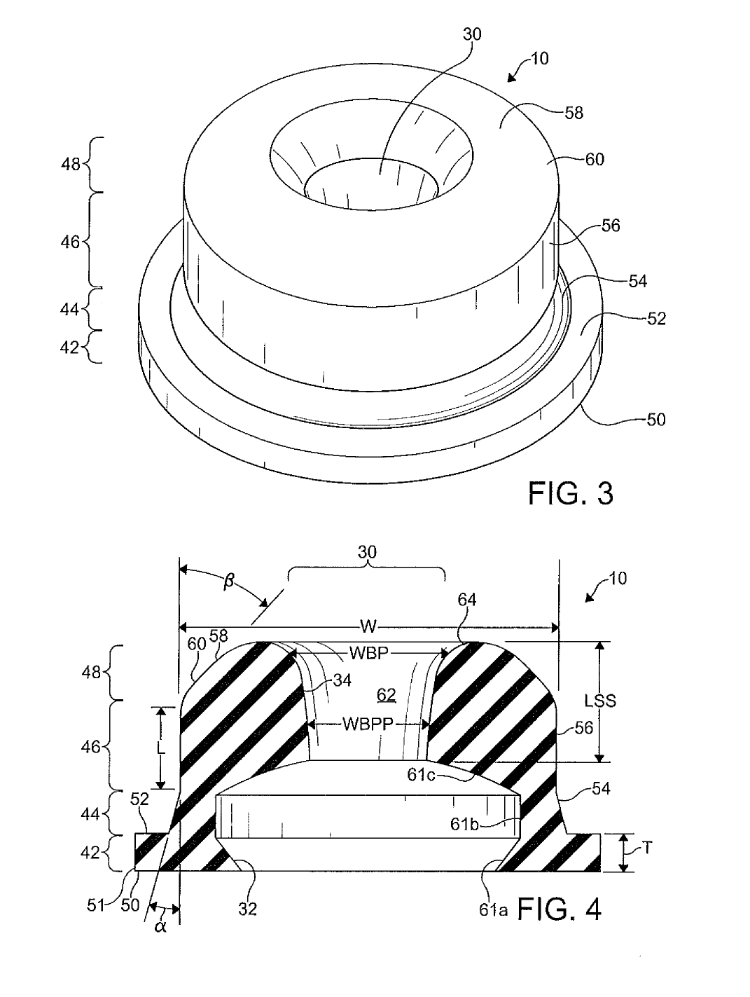

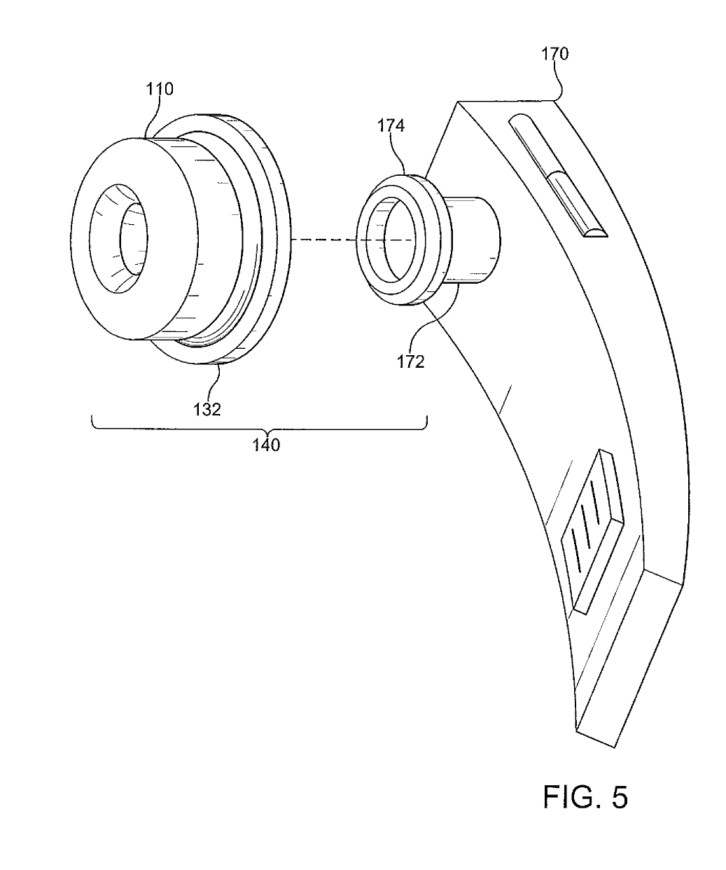

Referring now to FIGS. 3 and 4, the earpuff 10 includes a first region 42, a second region 44, a third region 46, a fourth region 48 and the inner passage 30. The first region 42 includes a first end 50 and an opposing shoulder 52. The first end 50 and the opposing shoulder 52 cooperate to form a circumferential tab 51. The shoulder 52 is configured to seat against portions of the outer ear 24 of the user as shown in FIG. 2. The tab 51 has a thickness T. The thickness T of the tab 51 is configured to provide structural support for the earpuff 10 in an installed position. In the illustrated embodiment, the thickness T of the tab 51 is in a range of from about 1.5 mm to about 3.0 mm. In other embodiments, the thickness T of the tab 51 can be less than about 1.5 mm or more than about 3.0 mm, sufficient to seat against the outer ear 24 of the user and provide structural support to the earpuff 10.

Referring again to FIGS. 3 and 4, the second region 44 extends from the first region 42 to the third region 46. The second region 44 has an outer circumferential surface 54, The outer surface 54 forms an angle α with a substantially vertical line. The angle α of the outer surface 54 is configured to allow the second region 44 of the earpuff 10 to seat comfortably against portions of the transition of the outer ear 24 with the inner ear 22 of the user as shown in FIG. 2. In the embodiment illustrated in FIGS. 3 and 4, the angle α is in a range of about 10.0° to about 30.0°. However, it should be appreciated that in other embodiments, the angle α can be less than about 10.0° or more than about 30.0°.

Referring again to FIGS. 3 and 4, the third region 46 extends from the second region 44 to the fourth region 48. The third region 46 includes a circumferential surface 56. The surface 56 is configured for seating of the earpuff 10 within portions of the ear canal 22 of the user as shown in FIG. 2, In the embodiment illustrated in FIGS. 3 and 4, the circumferential surface 56 is substantially vertical. The term “substantially vertical”, as used herein, is defined to mean vertical within a tolerance of about ±5.0°. However, it should be appreciated that in other embodiments, the circumferential surface 56 can have any orientation that facilitates seating of the earpuff 10 within portions of the ear canal 22 of the user.

The third region 46 has a width W and a length L. The width W closely corresponds to the width of portions of a typical ear canal 22 and the length L is configured to enhance the audio qualities of the sound produced by the earbud 12. In the illustrated embodiment, the width W is in a range of from about 14.0 mm to about 20.0 mm. Alternatively, the width W can be less than about 14.0 mm or more than about 20.0 mm. In the illustrated embodiment, the length L of the third region is in a range of from about 3.0 mm to about 8.0 mm. However, in other embodiments, the length L can be less than about 3.0 mm or more than about 8.0 mm.

The fourth region 48 extends from the third region 46 to a second end 58. The fourth region 48 has a circumferential outer surface 60. The outer surface 60 forms an angle β with a substantially vertical line. The angle β of the outer surface 60 is configured to facilitate easy entry of the earpuff assembly 40 into portions of the user's ear. In the illustrated embodiment, the angle β is in the range of about 30.0° to about 60.0°. However, it should be appreciated that in other embodiments, the angle β can be less than about 30.0° or more than about 60.0°.

Referring again to the embodiment shown in FIGS. 3 and 4, the shoulder 52 and the circumferential outer surfaces 54, 56 and 60 of the regions 42, 44, 46 and 48 have a smooth surface. The term “smooth surface”, as used herein, is defined to mean a continuous even surface. The smooth surfaces of the shoulder 52 and the circumferential outer surfaces 54, 56 and 60 are configured to facilitate ease of entry and removal of the earpuff assembly 40 into and out of a user's ear 20. Optionally, the shoulder 52 and the circumferential outer surfaces 54, 56 and 60 can be textured. The term “textured”, as used herein, is defined to mean having a non-smooth surface characteristic. As will be discussed in more detail below, the textured surfaces can improve adhesion with portions of a user's ear. The textured surfaces can be formed by any desired structure or combination of structures, including the non-limiting examples of grooves, cross-hatchings or granulations. In still other embodiments, the shoulder 52 and the circumferential outer surfaces 54, 56 and 60 can have additional layers or coatings configured to improve the adhesion with portions of a user's ears or configured to improve other desired properties such as for example antibacterial agents.

Referring again to FIGS. 3 and 4 and as discussed above, the earpuff 10 includes the inner passage 30. The inner passage 30 includes the first segment 32 and the second segment 34. The first segment 32 of the inner passage 30 is configured to receive a first portion 36 of the earbud 12. As discussed above, the first segment 32 of the earpuff 10 includes a plurality of interior contours 61a-61c that closely approximate the exterior contours of the first portion 36 of the earbud 12, such that in an installed position, the interior contours 61a-61c of the first segment 32 and the exterior contours of the first portion 36 align, thereby securely retaining the earbud 12 within the earpuff 10. While the embodiment illustrated in FIG. 4 shows a quantity of three interior contours 61a-61c, it should be appreciated that in other embodiments, more or less than three interior contours can be used sufficient to closely approximate the exterior contours of the first portion 36 of the earbud 12. Further, while the embodiment illustrated in FIG. 4 shows the interior contours 61a and 61c to have sloped circumferential surfaces and the interior contour 61b to have a substantially vertical circumferential surface, it is within the contemplation of this invention that the interior contours of the first segment 32 of the earpuff 10 can have circumferential surfaces with any desired orientation sufficient to closely approximate the exterior contours of the first portion 36 of the earbud 12.

Referring again to FIG. 4, the second segment 34 of the inner passage 30 is configured to enhance the audio qualities of the sound produced by the earbud 12. The second segment 34 includes a bell pipe 62 portion and a bell portion 64. The bell pipe portion 62 is configured to direct, focus and enhance the sounds emanating from the earbud 12. As shown in FIG. 4, the bell pipe portion 62 has a width WBPP that expands in the direction from the first segment 32 toward the bell portion 64. The expansion of the width WBPP of the bell pipe portion 62 contributes to the exceptional audio quality of the earpuff 10. In the illustrated embodiment, the width WBPP of the bell pipe portion at the intersection of the first segment 32 and the second segment 34 is in a range of from about 4.0 mm to about 8.0 mm and the width WBPP of the bell pipe portion 62 at the bell portion 64 is in a range of from about 6.0 mm to about 10.0 mm. However, the various widths WBPP of the bell pipe portions 62 can be different.

Referring again to FIG. 4, the bell portion 64 is configured to enhance the sounds emanating from the earbud 12. As shown in FIG. 4, the bell portion 64 has a width WBP that expands in the direction from the first segment 32 toward the second end 58. The expansion of the width WBP of the bell portion 64 contributes to the exceptional audio quality of the earpuff 10. In the illustrated embodiment, the width WBP of the bell portion 64 at the intersection of the bell pipe portion 62 is in a range of from about 6.0 mm to about 10.0 mm and the width WBP of the bell portion 64 at the second end 59 is in a range of from about 8.0 mm to about 14.0 mm. However, the various widths WBP of the bell portions 64 can be different.

The second segment 34 of the inner passage 30 has a length LSS. In the illustrated embodiment, the length LSS is in a range of from about 4.0 mm to about 8.0 mm. In other embodiments, the length LSS can be less than about 4.0 mm or more than about 8.0 mm.

Referring again to FIGS. 1 and 2, the earpuff 10 provides significant benefits over conventional earbuds 12, although all benefits may not be present in all embodiments and circumstances. First, the foam material forming the earpuff 10 is configured to form a temporary shape that conforms to the shape of portions of the ear canal 22 and portions of the outer ear 24 of the user, thereby comfortably retaining the earbud 10 until the earpuff 10 is removed by the user. Without being held to the theory, it is believed that the comfort afforded by the earpuff 10 stems from the ability of the compressed foam material to create a cushion that places less pressure on portions of the ear canal 22 and portions of the outer ear 24 by spreading air pressure within the cells of the foam material over adjoining cells. The spreading of the air pressure within the cells of the foam material advantageously improves the ability of the foam material to conform to the shape of the pressure points within the ear 20.

Second, by forming a close fit with portions of the ear canal 22 and portions of the outer ear 24, the foam material is further configured to substantially block the flow of ambient noise into portions of the ear canal 22. This allows the user to more consistently control the volume of the sound emanating from the mobile electronic device 14 as well as allowing the user to receive sounds having a truer quality and less distortion from the earbud 12.

Third, as discussed above, the foam material forming the earpuff 10 is a visco-elastic polymeric-based material foam material which compresses upon insertion into portions of the user's ear 20 and subsequently expands such as to automatically adjust the contours and shapes of the second, third and fourth regions, 44, 46 and 48, of the earpuff 10 to the individual shape of portions of the user's ear.

While the embodiment illustrated in FIG. 1-4 show the earpuff 10 in association with a conventional earbud 12, it is within the contemplation of this invention that the earpuff can be used with other electronic device, whether mobile or not. Referring now to FIG. 5, an earpuff 110 is illustrated with another embodiment of an electronic device. In this embodiment, the earpuff 110 is shown as used with a mobile ear phone 170. Non-limiting examples of mobile ear phones include the Bluetooth Monaural marketed by Plantronics, the Q2 marketed by BlueAnt and the EXTREME2 marketed by Jabra. The mobile ear phone 170 includes a speaker portion 172. The speaker portion 172 includes a contoured segment 174.

In operation, the earpuff 110 and the speaker portion 172 of the mobile ear phone 170 are used in the following manner. First, any existing foams or other soft materials (not shown) covering the contoured segment 174 of the speaker portion 172 are removed. Next, the contoured segment 174 is inserted into the first segment 132 of the earpuff 110 such that the exterior contours of the contoured segment 174 align with the interior contours of the first segment 132 of the earpuff 110, as shown in FIG. 1 and described above. In this position, the contoured segment 174 of the speaker portion 172 is securely retained within the first segment 132 of the earpuff 110. The assembly of the contoured segment 174 into the earpuff 110 forms an earpuff assembly 140. The earpuff assembly 140 is inserted into the user's ear as described above such that the foam material of the earpuff 110 compresses and subsequently expands to the approximate shape and dimensions of the user's ear canal 22 and outer ear 24.

In accordance with the provisions of the patent statutes, the principle and mode of operation of the earpuff have been explained and illustrated in its preferred embodiment. However, it must be understood that the earpuff may be practiced otherwise than as specifically explained and illustrated without departing from its spirit or scope.

What is claimed is:

1. An earpuff comprising a one-piece structure having a first end, a second end and an inner passage therebetween, wherein the inner passage has a first segment and a second segment, the first segment having a plurality of interior contours, the interior contours configured to align with exterior contours of a speaker component, wherein the second segment of the inner passage includes a bell pipe portion and a bell portion.

2. The earpuff of claim 1, wherein the speaker component is part of a mobile electronic device.

3. The earpuff of claim 1, wherein in an installed position, portions of the earpuff are configured to extend into an car canal of a user and portions of the earpuff are configured to seat against portions of an outer ear of the user.

4. The earpuff of claim 1, wherein the earpuff is formed from a biodegradable, visco-elastic polymeric-based open cell foam material.

5. The earpuff of claim 1, wherein the earpuff has a plurality of regions extending from the first end to the second end and wherein each of the regions has a circumferential surface.

6. The earpuff of claim 5, wherein each of the circumferential surfaces has a smooth surface.

7. The earpuff of claim 1, wherein the first end has an opposing shoulder, wherein the first end and the opposing shoulder cooperate to form a circumferential tab, and wherein the circumferential tab has a thickness in a range of from about 1.5 mm to about 3.0 mm.

8. The earpuff of claim 5, wherein a second region has a circumferential surface that forms an angle with a substantially vertical line, and wherein the angle is in a range of from about 10° to about 30°.

9. The earpuff of claim 5, wherein a third region has a circumferential surface that is oriented to be substantially perpendicular to the first end.

10. The earpuff of claim 5, wherein a fourth region has a circumferential surface that forms an angle with a substantially vertical line, and wherein the angle is in a range of from about 30° to about 60°.

11. The earpuff of claim 5, wherein a second region has a circumferential surface that forms an angle with a substantially vertical line, and wherein the angle is in a range of from about 10° to about 30°.

12. The earpuff of claim 5, wherein each of the circumferential surfaces has an anti-bacterial coating.

13. The earpuff of claim 1, wherein the first segment of the interior passage has a quantity of three interior contours.

14. The earpuff of claim 1, wherein the bell pipe portion of the second segment of the inner passage has a width that expands in the direction toward the second end.

15. The earpuff of claim 1, wherein the bell portion of the second segment of the inner passage has a width that expands in the direction toward the second end.

16. The earpuff of claim 1, wherein the second segment of the inner passage has a length in a range of from about 4.0 mm to about 8.0 mm.

17. The earpuff of claim 5, wherein a third region has a width in a range of from about 14.0 mm to about 20.0 mm.

18. The earpuff of claim 1, wherein the earpuff is formed from a foam material, and wherein the foam material has a hysteresis loss in a range of from about 50% strain at 500 Newtons to about 37% strain at 200 Newtons.

19. A method of using a speaker of an electronic device, the method comprising the steps of:
inserting a first portion of the speaker into a first segment of an earpuff, the first portion of the speaker having a plurality of exterior contours and the first segment of the earpuff having a plurality of interior contours, the combination of the speaker and the earpuff forming an earpuff assembly;
inserting the earpuff assembly into an ear of a user such that portions of the earpuff extend into portions of an ear canal and portions of the earpuff seat against portions of an outer ear; and
allowing the earpuff to expand against portions of the ear canal and portions of the outer ear, thereby creating a personal fit.

20. The method of claim 18, wherein the earpuff is formed from a biodegradable, visco-elastic polymeric-based open cell foam material.
